(19) United States
(12) Patent Application Publication
(10) Pub. No.: US 2026/0158762 A1
(43) Pub. Date: Jun. 11, 2026

(54) SINGLE OR DOUBLE LYOCELL NETTING BASED BIODEGRADABLE EROSION CONTROL BLANKET

(71) Applicant: MKB Company, LLC, Westerville, OH (US)

(72) Inventors: Britt Faucette, Decatur, GA (US); Nick Dreher, Sarver, PA (US)

(21) Appl. No.: 19/180,272

(22) Filed: Apr. 16, 2025

Related U.S. Application Data
(60) Provisional application No. 63/634,759, filed on Apr. 16, 2024.

(51) Int. Cl. B32B 5/26; B32B 5/02; E02D 17/20

(52) U.S. Cl. CPC B32B 5/262; B32B 5/024; E02D 17/202; B32B 2262/065; B32B 2307/7163; B32B 2410/00

(57) ABSTRACT

An erosion control blanket includes one or two layers of lyocell netting and a biodegradable substrate of natural fibers such as formed of one of straw, coconut fiber, excelsior fiber and mixtures thereof. The biodegradable erosion control blankets 10 and 10′ are appropriate for any bare soil area where temporary protection from raindrop and wind erosion is needed, or where newly seeded grass requires short-term cover and support prior to germination, early growth, and full establishment. Erosion control blankets are generally effective for slopes up to 1H:1V

### RELATED APPLICATIONS

The present application claims the benefit of U.S. Provisional Patent Application Ser. No. 63/634,759 filed Apr. 16, 2024 titled “Single or Double Lyocell Netting Based Biodegradable Erosion Control Blanket” which is incorporated herein by reference.

### BACKGROUND OF THE INVENTION

### 1. Field of the Invention

This invention generally relates to environmentally friendly erosion control blankets.

### 2. Background Information

Uncontrolled storm-water runoff from construction sites can significantly impact rivers, lakes, and estuaries. Sediment in waterbodies from construction sites can reduce the amount of sunlight reaching aquatic plants, clog fish gills, smother aquatic habitat and spawning areas, and impede navigation.

Various erosion control products have been designed to minimize erosion from storm-water runoff, including erosion control blankets. Degradable erosion control blankets are typically formed of a biodegradable substrate of natural fibers formed as a blanket that provide temporary cover and support for establishing vegetation on bare soil areas. The substrate of natural fibers is often formed on single netting or sandwiched between two netting layers.

Erosion control blankets provide cover for bare soil and support for emergent vegetation (i.e., typically grass) from the time of seeding until root density and top growth are capable of long-term erosion protection. Erosion control blankets function by shielding bare soil and newly seeded areas against raindrop and wind erosion, providing a dense matrix of biodegradable material (e.g., straw, coconut fibers) that stabilizes and supports emergent vegetation and later decomposes to further aid in plant growth. Erosion control blankets also help to increase precipitation infiltration and decrease soil crusting and compaction. Erosion control blankets are designed and fabricated in a variety of types that last from a few months to approximately three years. Temporary Erosion control blankets can be grouped into categories based on functional longevity, according to the Erosion Control Technology Council, Category 1: Ultra short-term—typically 3 months, Category 2: Short-term—typically 12 months, Category 3: Extended term—typically 24 months, Category 4: Long-term—typically 36 months.

Biodegradable erosion control blankets are appropriate for any bare soil area where temporary protection from raindrop and wind erosion is needed, or where newly seeded grass requires short-term cover and support prior to germination, early growth, and full establishment. Erosion control blankets are typically used where vegetation requires only temporary support for establishment, such as flat upland areas and slopes less than four to one grade (4H:1V). Erosion control blankets are also effective in establishing vegetation on relatively flat shoreline areas, swales, ditches, and athletic fields, or grassy areas that will be mowed closely such as places where longer term plastic mesh material may cause a tripping hazard or be pulled up later by equipment. Erosion control blankets can also be used as temporary cover for small bare areas that are idle for a few weeks (i.e., time periods too long to remain unprotected, but too short to seed). In these cases, Erosion control blankets can be unrolled on bare portions of the site for a short period, removed when work commences, and reused. Erosion control blankets can be especially useful for establishing permanent vegetation on slopes 2H:1V or greater. Erosion control blankets are generally effective for slopes up to 1.5H:1V, but may be used for slopes as steep as 1H:1V.

Erosion control blankets are effective in reducing rill, sheet, and wind erosion of bare soil on a range of situations, including slopes, swales, ditches, channels, and shore areas. Although their erosion reduction performance is generally 90 percent or more, their ultimate effectiveness is dependent upon the quality of surface preparation, installation methods (i.e., soil contact, staking pattern), and site conditions (e.g., slopes, soils, rainfall, etc.).

The netting layer(s) on each category 1 erosion control blanket generally start to decompose after one month with 80 percent breakdown occurring within three months. Category 2 and 3 erosion control blankets have the netting layer(s) generally contain sufficient UV stabilization for breakdown to occur within a normal growing season. Category 4 erosion control blankets have the netting layer(s) generally UV stabilized to provide a service life of two to three years. For erosion control blankets with two netting layers the fiber material is sandwiched between a top and a bottom netting layer. The fiber material in each erosion control blanket should be securely attached to the netting layer(s) to prevent movement of the fiber.

Although synthetic netting layers of conventional erosion control blankets is considered “degradable” (often photo-degradable), it is a source of microplastics. Microplastics are fragments of any type of plastic less than 5 mm (0.20 in) in length, according to the U.S. National Oceanic and Atmospheric Administration (NOAA) and the European Chemicals Agency. Microplastics cause pollution by entering natural ecosystems. Secondary microplastics arise from the degradation (breakdown) of larger plastic products through natural weathering processes after entering the environment. Secondary microplastics are recognized to persist in the environment at high levels, particularly in aquatic and marine ecosystems, where they cause water pollution. Microplastics also accumulate in the air and terrestrial ecosystems.

Microplastics have a high probability of ingestion, incorporation into, and accumulation in the bodies and tissues of many organisms. In terrestrial ecosystems, microplastics have been demonstrated to reduce the viability of soil ecosystems and reduce weight of earthworms. The cycle and movement of microplastics in the environment are not fully known. Microplastics have also been found in human blood, though their effects are largely unknown.

Erosion control blankets with natural fiber nettings, generally cotton or jute fibers, do not create microplastics during decomposition, however they fail to yield the performance characteristics of erosion control blankets with plastic nettings.

There remains a need in the art to a simple cost effective erosion control blankets with natural fiber netting having the performance of plastic netting.

### SUMMARY OF THE INVENTION

The various embodiments and examples of the present invention as presented herein are understood to be illustrative of the present invention and not restrictive thereof and are non-limiting with respect to the scope of the invention.

The present invention provides a single or double lyocell netting based biodegradable erosion control blanket.

One aspect of the invention provides an erosion control blanket includes at least one regenerated cellulose netting material and a biodegradable substrate of natural fibers formed of one of straw, coconut fiber, excelsior fiber and mixtures thereof. The erosion control blanket according to the present invention may be provide wherein the netting includes a single layer or a regenerated cellulose upper netting material and a regenerated cellulose lower netting material. The erosion control blanket according to the present invention may be provide wherein each regenerated cellulose netting material is woven in an open weave having opening size of about ¼″-2″. The erosion control blanket according to the present invention may be provide wherein each regenerated cellulose netting material further includes natural fibers such as one of cotton, hemp, jute and mixtures thereof.

These and other advantages of the present invention will be clarified in the description of the preferred embodiments taken together with the attached figures.

### BRIEF DESCRIPTION OF THE FIGURES

FIG. 1 is a schematic exploded view of a double lyocell netting based biodegradable erosion control blanket according to one embodiment of the present invention.

FIG. 2 is a schematic side elevation view of the double lyocell netting based biodegradable erosion control blanket of FIG. 1.

FIG. 3 is a schematic side elevation view of a single lyocell netting based biodegradable erosion control blanket according to another embodiment of the present invention.

FIG. 4 is a schematic perspective view of lyocell netting used in the biodegradable erosion control blankets of FIGS. 1-3 according to the present invention.

FIG. 5 is a schematic side elevation view of the Lyocell Netting of FIG. 4.

FIG. 6 is a perspective view of the biocompatible erosion control blanket of FIG. 1 or 3 according to the present invention used in the field.

### DESCRIPTION OF THE PREFERRED EMBODIMENTS

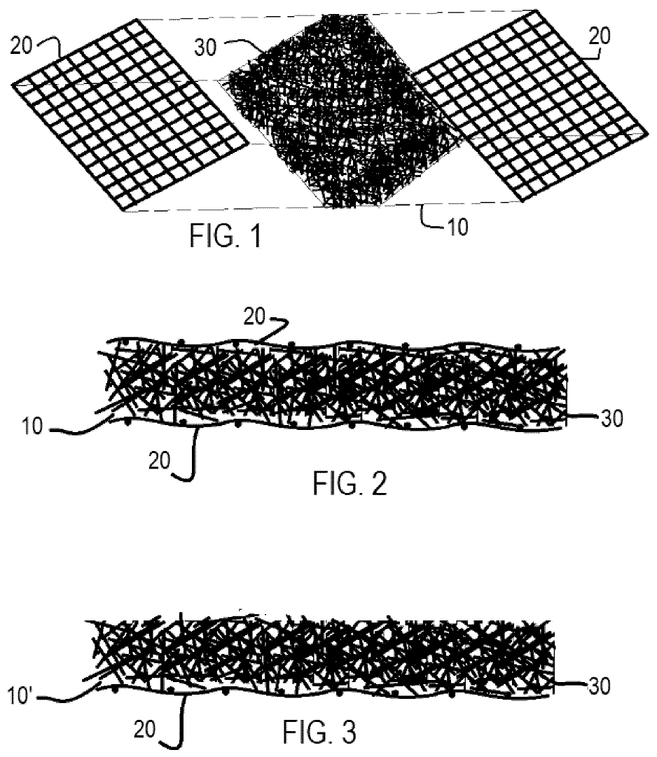

The present invention provides a double lyocell netting based biodegradable erosion control blanket 10 shown in FIGS. 1-2. The erosion control blanket 10 shown in FIGS. 1-2 includes two layers 20 of lyocell netting around a biodegradable substrate 30 of natural fibers such as straw, coconut fiber, excelsior fiber and mixture thereof. Excelsior fibers is a product made from wood slivers cut from logs.

The lyocell netting is formed of lyocell threads woven in an open weave having opening size of about ¼″-2″. Lyocell is a form of regenerated cellulose made by dissolving pulp and dry jet-wet spinning. Unlike rayon; which is made by the more common viscose processes, Lyocell production does not use carbon disulfide, which is toxic to workers and the environment. The U.S. Federal Trade Commission defines Lyocell as “a fiber composed of cellulose precipitated from an organic solution in which no substitution of the hydroxy groups takes place, and no chemical intermediates are formed”.

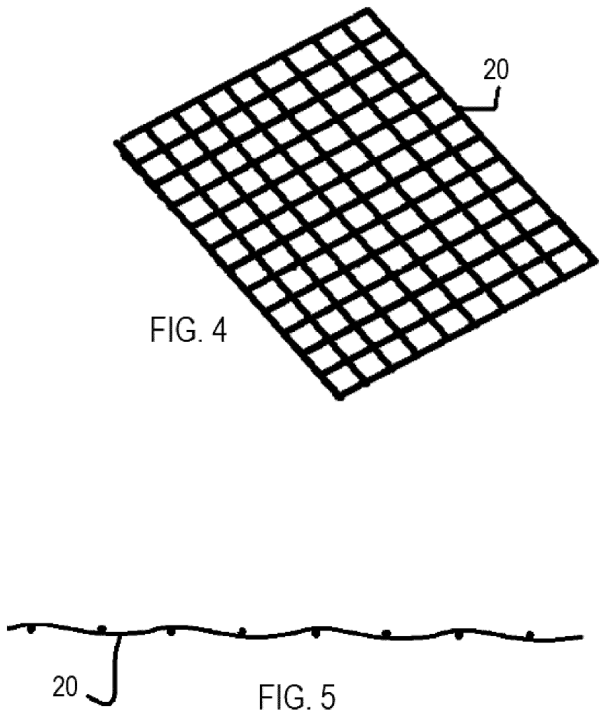

The Lyocell netting 20, shown in FIGS. 4 and 5 is preferably formed with 100% lyocell thread, however to adjust the erosion control blanket 10 parameters for shorter life the lyocell threads may be blended with a variety of other natural fibers (less than 50% by weight of other natural fibers) such as cotton, hemp and jute (and mixtures thereof). When mixed with other fibers, the resulting erosion control blanket 10 is stronger and more resistant to wear than an erosion control blanket 10 made with cotton, hemp or jute fiber. A lyocell netting within the meaning of this application is an open weave structure formed of threads having at over 50% by weight lyocell. Open weave means opening size of at least ¼″.

In manufacturing of the erosion control blanket 10, the loose fiber material forming the biodegradable substrate 30, namely straw, coconut fiber, excelsior fiber and mixture thereof, is generally sorted to obtain desired fiber lengths and then treated with an ecofriendly binder and placed upon the lower netting layer 20 and the upper netting layer 20 is placed on top, generally in a continuous or semi-continuous fashion.

The preferred substrate 30 is 100% straw. However, combinations of straw and coconut fiber, 100% coconut fiber, straw and excelsior fiber (Aka wood wool) and 100% excelsior fiber are also suitable. For example, one preferential alternative blanket 10 is a mix of 70% straw and 30% coconut fiber for substrate 30 with upper and lower lyocell thread netting 20. Another preferential alternative blanket 10 is a 100% Coconut fiber for substrate 30 with upper and lower lyocell thread netting 20.

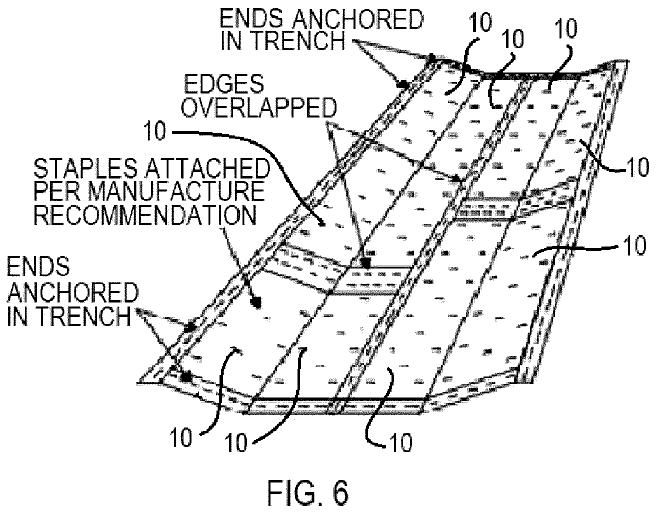

The completed erosion control blanket 10 is typically rolled for ease of shipping and deployment, with variable lengths, but 50′, 100′ and 200′ being common. In deploying the blanket 10, with a typical use shown in in FIG. 6, the blanket is moved to location, rolled into position and stapled or staked to the ground. The blanket 10 gives performance characteristics of plastic netting based blankets without being a source of microplastics. The blankets 10 are fully degradable without detrimental effects on the environment.

The present invention provides a single lyocell netting based biodegradable erosion control blanket 10′ shown in FIG. 32. The erosion control blanket 10′ includes one layer 20 of lyocell netting shown in FIGS. 4-5 with a biodegradable substrate 30 of natural fibers such as straw, coconut fiber, excelsior fiber and mixture thereof. The lyocell netting 20 for the blanket 10′ is as described above and is shown in FIGS. 4 and 5 and is preferably formed with 100% lyocell thread. Again, to adjust the erosion control blanket 10′ parameters for shorter life the lyocell threads may be blended with a variety of other natural fibers (less than 50% by weight of other natural fibers) such as cotton, hemp and jute. In manufacturing of the erosion control blanket 10′, similar to the blanket 10 the loose fiber material forming the biodegradable substrate 30, namely straw, coconut fiber, excelsior fiber and mixture thereof, is generally sorted to obtain desired fiber lengths and then treated with an ecofriendly binder and placed upon the single netting layer 20.

The completed erosion control blanket 10′ is typically rolled for ease of shipping and deployment, with variable lengths, but 50′, 100′ and 200′ being common. In deploying the blanket 10′, with a typical use shown in in FIG. 6, the blanket 10′ is moved to location, rolled into position and stapled or staked to the ground. The blanket 10′ gives performance characteristics of plastic netting based blankets without being a source of microplastics. The blanket 10′ is fully degradable without detrimental effects on the environment.

The preferred blankets 10 or 10′ are in either 8′ or 16′ rolls at varying lengths (typically 50′, 100′ and 200′). Field longevity will be dictated by soil and climate conditions during install and length of a given project, however a blanket 10′ with 100% Straw filler 30 stitched to a single lyocell net 20 on top can have a life expectancy of 3-12 months. A blanket 10 with filler 30 which consists of 70% Straw and 30% Coconut fiber with top and bottom lyocell netting 20 yields a life span of 12-24 months.

The lyocell netting 20 used for the blankets 10 and 10′ described above and as shown in FIGS. 4 and 5 may possibly be used individually without the material 30 (i.e. not as a blanket 10 or 10′). For example, the netting 20 may be used over compost blanketing for stabilization of the same.

The biodegradable erosion control blankets 10 and 10′ are appropriate for any bare soil area where temporary protection from raindrop and wind erosion is needed, or where newly seeded grass requires short-term cover and support prior to germination, early growth, and full establishment. Erosion control blankets 10 or 10′ may be used where vegetation requires only temporary support for establishment, such as flat upland areas and slopes less than four to one grade (4H:1V). Erosion control blankets 10 or 10′ are also effective in establishing vegetation on relatively flat shoreline areas, swales, ditches, and athletic fields, or grassy areas that will be mowed closely such as places where longer term plastic mesh material may cause a tripping hazard or be pulled up later by equipment. Erosion control blankets 10 or 10′ may also be used as temporary cover for small bare areas that are idle for a few weeks (i.e., time periods too long to remain unprotected, but too short to seed). Erosion control blankets 10 or 10′ may be especially useful for establishing permanent vegetation on slopes 2H:1V or greater. Erosion control blankets 10 or 10′ are generally effective for slopes up to 1.5H:1V, but may be used for slopes as steep as 1H:1V. Erosion control blankets 10 and 10′ are effective in reducing rill, sheet, and wind erosion of bare soil on a range of situations, including slopes, swales, ditches, channels, and shore areas.

While this invention has been particularly shown and described with references to the preferred embodiments thereof, it will be understood by those skilled in the art that various changes in form and details may be made therein without departing from the scope of the invention.

What is claimed is:

1. An erosion control blanket includes at least one layer of lyocell netting and a biodegradable substrate of natural fibers.

2. The erosion control blanket according to claim 1, wherein each lyocell netting is formed of 100% lyocell.

3. The erosion control blanket according to claim 2, wherein each lyocell netting is woven in an open weave having opening size of about ¼″-2″.

4. The erosion control blanket according to claim 3, wherein the biodegradable substrate is formed of one of straw, coconut fiber, excelsior fiber and mixtures thereof.

5. The erosion control blanket according to claim 4, wherein the lyocell netting includes an upper lyocell netting and a lower lyocell netting.

6. The erosion control blanket according to claim 4, wherein the lyocell netting includes a single layer of lyocell netting.

7. The erosion control blanket according to claim 1, wherein each lyocell netting is formed of a mixture of lyocell and natural fibers.

8. The erosion control blanket according to claim 7, wherein the natural fibers in the lyocell netting includes one of cotton, hemp, jute and mixtures thereof.

9. The erosion control blanket according to claim 8, wherein each lyocell netting is woven in an open weave having opening size of about ¼″-2″.

10. The erosion control blanket according to claim 9, wherein the biodegradable substrate is formed of one of straw, coconut fiber, excelsior fiber and mixtures thereof.

11. The erosion control blanket according to claim 10, wherein the lyocell netting includes an upper lyocell netting and a lower lyocell netting.

12. The erosion control blanket according to claim 10, wherein the lyocell netting includes a single layer of lyocell netting.

13. An erosion control blanket includes at least one regenerated cellulose netting material and a biodegradable substrate of natural fibers formed of one of straw, coconut fiber, excelsior fiber and mixtures thereof.

14. The erosion control blanket according to claim 13, wherein the netting includes a regenerated cellulose upper netting material and a regenerated cellulose lower netting material.

15. The erosion control blanket according to claim 13, wherein each regenerated cellulose netting material is woven in an open weave having opening size of about ¼″-2″.

16. The erosion control blanket according to claim 13, wherein each regenerated cellulose netting material further includes natural fibers.

17. The erosion control blanket according to claim 16, wherein the natural fibers in the netting material includes one of cotton, hemp, jute and mixtures thereof.

18. The erosion control blanket according to claim 13, wherein the netting material includes a single layer of regenerated cellulose netting material.

19. The erosion control blanket according to claim 13, wherein the regenerated cellulose netting material is woven in an open weave having opening size of about ¼″-2″.

20. The erosion control blanket according to claim 13, wherein each regenerated cellulose netting material further includes natural fibers including one of cotton, hemp, jute and mixtures thereof.
